(19) United States
(12) Patent Application Publication
(10) Pub. No.: US 2013/0291896 A1
(43) Pub. Date: Nov. 7, 2013

(54) DISHWASHER APPLIANCE WITH FEATURES FOR DETERMINING A DRAIN TIME INTERVAL

(71) Applicants: Kyle Edward Durham, Louisville, KY (US); Gregory Owen Miller, Louisville, KY (US)

(72) Inventors: Kyle Edward Durham, Louisville, KY (US); Gregory Owen Miller, Louisville, KY (US)

(73) Assignee: GENERAL ELECTRIC COMPANY, Schenectady, NY (US)

(21) Appl. No.: 13/465,478

(22) Filed: May 7, 2012

(51) Int. Cl. A47L 15/46; B08B 7/04; B08B 3/04

(52) U.S. Cl. 134/18; 134/56 D; 134/113

(57) ABSTRACT

A dishwasher appliance is provided. The dishwasher appliance includes features for determining a drain time interval or a fluid drain rate of fluid exiting the appliance. The drain time interval or the fluid drain rate can be used to more accurately gauge the amount of fluid contained within the appliance and, in turn, increase the efficiency of the appliance.

### FIELD OF THE INVENTION

The present subject matter relates generally to dishwasher appliances with features for calculating a drain time interval or a fluid drain rate.

### BACKGROUND OF THE INVENTION

Dishwasher appliances generally define a wash chamber that receives articles for washing. During operation, the wash chamber is filled and emptied according to desired wash sequences. During such wash sequences, water, detergent, and electricity are consumed in order to operate the dishwasher appliance and clean articles therein. Dishwasher manufacturers have focused on increasing the efficiency of dishwasher appliances. The focus includes monitoring and controlling the amount of electricity, the amount of detergent, and/or the amount of water used by a dishwasher appliance in an attempt to provide efficient and environmentally sensitive machines.

During operation of a dishwasher appliance, a wash fluid can be formed from water and detergent for cleaning articles disposed within the dishwasher appliance. Such wash fluid can become laden and/or saturated with food particulates during cleaning of the articles. Conventional dishwasher controls completely drain and replace the wash fluid between cycles. However, due to variations between loads of articles, the wash fluid may not require complete replacement. For example, certain loads of articles are only lightly soiled such that the wash fluid remains relatively clean during an initial wash cycle. Further, to continue cleaning the articles during a subsequent wash cycle, such wash fluid may require only dilution.

Accordingly, certain dishwasher appliances include features draining a portion of the wash fluid from the appliance and replacing the drained portion with cleaner water to dilute the wash fluid. By replacing only a portion of the dirty wash fluid rather than the entire volume, valuable water, detergent, and/or electricity can be conserved. However, to properly partially drain the dishwasher appliance, accurate drain rates can be necessary.

Conventional dishwasher controls often use timers to determine how long certain cycles of the dishwasher appliance run. For example, a pump may be turned on for a predetermined amount of time to drain the wash chamber. Such predetermined amounts of time are often conservative and are calculated based upon an average amount of time needed to drain the appliance. However, actual drain rates for dishwasher appliances can vary between households due to a variety of factors, e.g., drain pipe height, drain pipe geometry, potential clogging, etc. Thus, using a timing control as described above may provide effective yet less than optimal performance. For example, use of a timing control may not provide a suitably accurate mechanism for partially draining a dishwasher appliance.

Accordingly, more accurate systems and methods for determining a fluid drain rate for an appliance would be useful.

### BRIEF DESCRIPTION OF THE INVENTION

Aspects and advantages of the invention will be set forth in part in the following description, or may be apparent from the description, or may be learned through practice of the invention.

A dishwasher appliance is provided. The dishwasher appliance includes features for determining a drain time interval or a fluid drain rate of fluid exiting the appliance. The drain time interval or the fluid drain rate can be used to more accurately gauge the amount of fluid contained within the appliance and, in turn, increase the efficiency of the appliance.

In a first exemplary embodiment, a dishwasher appliance is provided. The dishwasher appliance includes a tub that defines a wash chamber for receipt of articles for washing. An inlet assembly selectively permits a flow of liquid into the wash chamber of the tub. A drain assembly selectively draws a flow of liquid out of the wash chamber of the tub. A flow meter is configured for measuring a flow rate of the flow of liquid into the wash chamber through the inlet assembly. A switch assembly is configured for operating in a first state when liquid fills the wash chamber above a certain level and for operating in a second state when liquid fills the wash chamber below the certain level. A processing device is in communication with the flow meter and the switch assembly. The processing device is configured for receiving rate R_{v/t} from the flow meter and for receiving a signal from the switch assembly when the switch assembly adjusts from the first state to the second state. The processing device is configured for determining a drain time interval based at least in part on rate R_{v/t} and the signal from the switch assembly. The drain time interval corresponds to an amount of time needed for a particular volume of liquid to exit the wash chamber of the tub through the drain assembly.

In a second exemplary embodiment, a method for operating a dishwasher appliance is provided. The method includes: initiating a flow of liquid into a wash chamber of the dishwasher appliance; monitoring the flow of liquid into the wash chamber with a flow meter in order to generate a flow rate, R_{v/t}, for the flow of liquid into the wash chamber; terminating the flow of liquid into the wash chamber of the dishwasher appliance; noting a first volume of liquid, V₁, that corresponds to a volume of liquid contained within the wash chamber at about the step of terminating where volume V₁ is based at least in part on rate R_{v/t}; commencing a flow of liquid out of the wash chamber of the dishwasher appliance; detecting a switch assembly changing state when a second volume of liquid, V₂, fills the wash chamber; and determining a time interval corresponding to an amount of time between about the step of commencing and about the step of detecting.

In a third exemplary embodiment, a dishwasher appliance is provided. The dishwasher appliance includes a tub that defines a wash chamber. A drain assembly selectively draws a liquid out of the wash chamber of the tub. The dishwasher appliance also includes means for calculating a fluid drain rate of the drain assembly.

These and other features, aspects and advantages of the present invention will become better understood with reference to the following description and appended claims. The accompanying drawings, which are incorporated in and constitute a part of this specification, illustrate exemplary embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a side partial cut-away view of a dishwasher appliance according to an exemplary embodiment of the present subject matter.

FIG. 2 is a schematic view of a fluid system of the dishwasher appliance of FIG. 1.

FIG. 3 provides a perspective view of a portion of a bottom of the dishwasher appliance of FIG. 1.

FIG. 4 provides a perspective view of the dishwasher portion of FIG. 3 with a filter cover removed showing a float sensor within a sump.

FIG. 5 provides a diagrammatical cross-sectional view of a float sensor within the sump of FIG. 5.

FIG. 6 provides a flow chart for an exemplary method of operating a dishwasher appliance such as the dishwasher appliance shown in FIG. 1.

FIG. 7 provides a flow chart for another exemplary method of operating a dishwasher appliance such as the dishwasher appliance shown in FIG. 1.

### DETAILED DESCRIPTION OF THE INVENTION

Reference now will be made in detail to exemplary embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

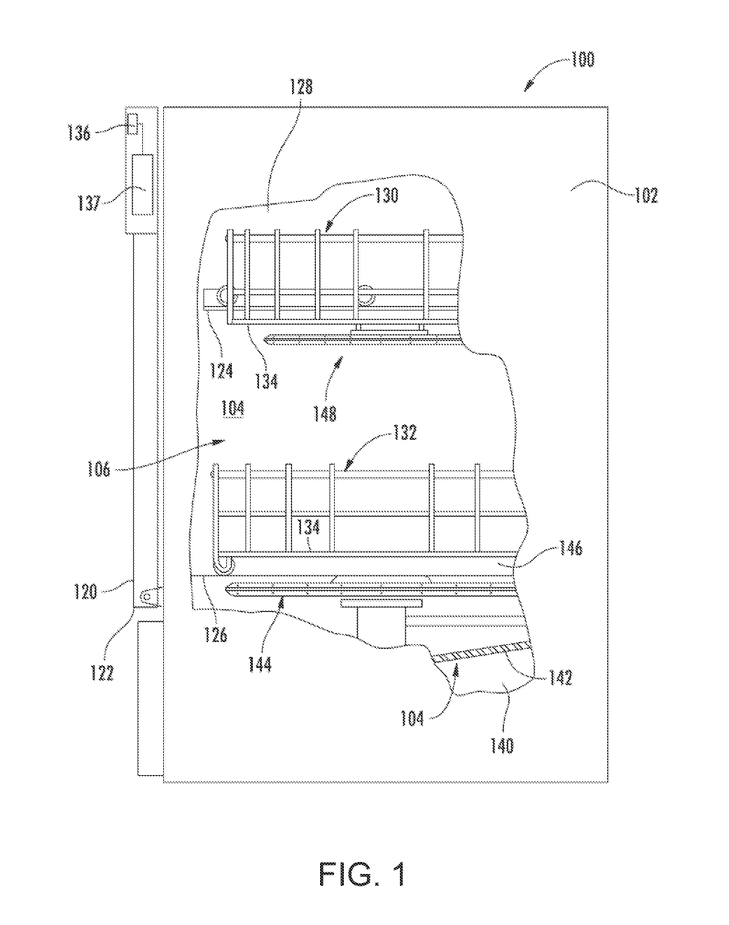

FIG. 1 depicts an exemplary embodiment of a domestic dishwasher appliance 100. Dishwasher appliance 100 includes a cabinet 102 having a tub 104 therein that defines a wash chamber 106. Tub 104 has a door 120 hinged at its bottom 122 for movement between a normally closed vertical position (shown in FIG. 1) wherein wash chamber 106 is sealed shut for washing operation, and a horizontal open position for loading and unloading of articles from dishwasher 100.

Upper and lower guide rails 124, 126 are mounted on tub side walls 128 and accommodate upper and lower roller-equipped racks 130, 132, respectively. Each of upper and lower racks 130, 132 is fabricated into lattice structures including a plurality of elongate members 134, and each rack 130, 132 is adapted for movement between an extended loading position (not shown) in which rack is substantially positioned outside wash chamber 106, and a retracted position (shown in FIG. 1) in which rack is located inside wash chamber 106. A silverware basket (not shown) may be removably attached to lower rack 132 for placement of silverware, utensils, and the like, that are too small to be accommodated by upper and lower racks 130, 132.

Dishwasher 100 further includes a lower spray assembly 144 that is, e.g., rotatably mounted within a lower region 146 of wash chamber 106 and above a tub sump portion 142 so as to be in relatively close proximity to lower rack 132. A mid-level spray assembly 148 is located in an upper region of wash chamber 106 and may be located in close proximity to upper rack 130. Additionally, an upper spray assembly (not shown) may be located above upper rack 130.

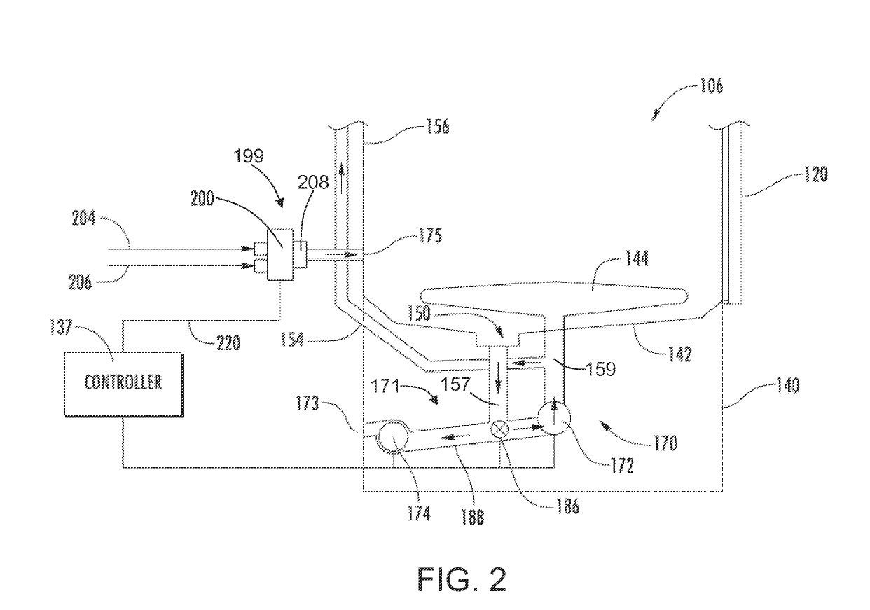

Lower and mid-level spray assemblies 144, 148 and the upper spray assembly are fed by a fluid circulation assembly (such as, e.g., fluid circulation 170 shown in FIG. 2) for circulating water and dishwasher fluid in tub 104. The fluid circulation assembly may be located in a machinery compartment 140 located below bottom sump portion 142 of tub 104, as generally recognized in the art. Each spray assembly includes an arrangement of discharge ports or orifices for directing washing fluid onto dishes or other articles located in upper and lower racks 130, 132, respectively. When the spray assemblies are configured for rotation, the arrangement of the discharge ports may provide a rotational force by virtue of washing fluid flowing through the discharge ports. The resultant rotation provides coverage of dishes and other dishwasher contents with a washing spray.

Dishwasher 100 is further equipped with a processing device or controller 137 to regulate operation of dishwasher 100. Controller 137 may include a memory and microprocessor, such as a general or special purpose microprocessor operable to execute programming instructions or micro-control code associated with a cleaning cycle. The memory may represent random access memory such as DRAM, or read only memory such as ROM or FLASH. In one exemplary embodiment, the processor executes programming instructions stored in memory. The memory may be a separate component from the processor or may be included onboard within the processor.

Controller 137 may be positioned in a variety of locations throughout dishwasher 100. In the illustrated exemplary embodiment, controller 137 may be located within a control panel area of door 120 as shown. In such an embodiment, input/output (“I/O”) signals may be routed between the control system and various operational components of dishwasher 100 along wiring harnesses that may be routed through bottom 122 of door 120. Typically, controller 137 includes a user interface panel 136 through which a user may select various operational features and modes and monitor progress of dishwasher 100. In one exemplary embodiment, user interface 136 may represent a general purpose I/O (“GPIO”) device or functional block. In one exemplary embodiment, user interface 136 may include input components, such as one or more of a variety of electrical, mechanical or electro-mechanical input devices including rotary dials, push buttons, and touch pads. User interface 136 may include a display component, such as a digital or analog display device designed to provide operational feedback to a user. User interface 136 may be in communication with controller 137 via one or more signal lines or shared communication busses.

It should be appreciated that the invention is not limited to any particular style, model, or other configuration of dishwasher, and that the exemplary embodiment depicted in FIG. 1 is for illustrative purposes only. For example, instead of racks 130, 132 depicted in FIG. 1, dishwasher 100 may be of a known configuration that utilizes drawers that pull out from the cabinet and are accessible from the top for loading and unloading of articles. Also, the present subject matter may be utilized in other appliance as well, e.g., washing machine appliances.

FIG. 2 schematically illustrates an exemplary embodiment of a fluid circulation assembly 170 positioned below wash chamber 106. Although one exemplary embodiment of fluid circulation assembly 170 that is operable to perform in accordance with aspects of the disclosure is shown, it should be understood that other fluid circulation assembly configurations may similarly be utilized without departing from the spirit and scope of the invention.

A drain assembly 171 of fluid circulation assembly 170 is configured for selectively removing liquid from wash chamber 106. Drain assembly 171 includes a drain pump 174 in fluid communication with sump 150 through fluid channel 157. Additionally, drain pump 174 is in fluid communication with an external drain 173 to discharge used wash fluid. For example, drain 173 may be in fluid communication with a sewer or septic system (not shown).

As shown, a drain valve 186 is established in fluid communication with sump 150 and selectively opens or closes flow communication between sump 150 and a drain pump inlet 188. Drain pump 174 is in fluid communication with drain pump inlet 188 and may pump fluid at inlet 188 to an external drain system via drain 173. In one exemplary embodiment, when drain pump 174 is energized, a negative pressure is created in drain pump inlet 188 and drain valve 186 is opened, allowing fluid in sump 150 to flow into fluid pump inlet 188 and be discharged from fluid circulation assembly 170 via external drain 173.

Fluid circulation assembly 170 includes a circulation pump 172 in fluid communication with sump 150. Circulation pump 172 is in fluid communication with lower spray assembly 144 through fluid channel 159 and in fluid communication with conduit 154, which extends to a back wall 156 of wash chamber 106 and upward along back wall 156 for feeding wash fluid to mid-level spray assembly 148 (FIG. 1) and the upper spray assembly. This configuration also applies to a drawer-type of dishwasher, as mentioned above.

As wash fluid is pumped through lower spray assembly 144, and further delivered to mid-level spray assembly 148 and the upper spray assembly (not shown), washing sprays are generated in wash chamber 106, and wash fluid collects in sump 150. Sump 150 may include a cover to prevent larger objects from entering sump 150, such as a piece of silverware or another object that is dropped beneath lower rack 132. A coarse filter and a fine filter (not shown) may be located adjacent sump 150 to filter wash fluid for sediment and particles of predetermined sizes before flowing into sump 150.

A turbidity sensor (not shown) may be coupled to sump 150 and used to sense a level of sediment in sump 150 and to initiate a sump purge cycle where the contents or a fractional volume of the contents of sump 150 are discharged when a turbidity level in sump 150 approaches a predetermined threshold.

Referring to FIG. 2, sump 150 is filled with water through an inlet assembly 199 with an inlet port 175 which feeds into wash chamber 106, as described in greater detail below. Inlet assembly 199 includes a water supply 200 that may be configured with inlet port 175 for selectively supplying wash fluid to wash chamber 106. Water supply 200 may provide hot water only, cold water only, or either, selectively, as desired. As depicted, water supply 200 has a hot water inlet 204 that receives hot water from an external source, such as a hot water heater and a cold water input 206 that receives cold water from an external source. It should be understood that the term “water supply” is used herein to encompass any manner or combination of valves, lines or tubing, housing, and the like, and may simply comprise a conventional hot or cold water connection.

A flow meter 208 is configured for measuring a flow rate of liquid entering dishwasher appliance 100 through inlet assembly 199. From such measurements, a volume of liquid contained within sump 150 of dishwasher appliance 100 may be calculated. For example, water supply 200 may permit a flow of water into wash chamber 106 through inlet port 175 for a period of time. Controller 137 or some other component of dishwasher appliance 100 may measure the period of time and, as discussed in greater detail below, using the measurement of the period of time and the measurement of the flow rate of water (as measured by flow meter 208) into wash chamber 106, a volume of liquid contained in wash chamber 106 may be determined.

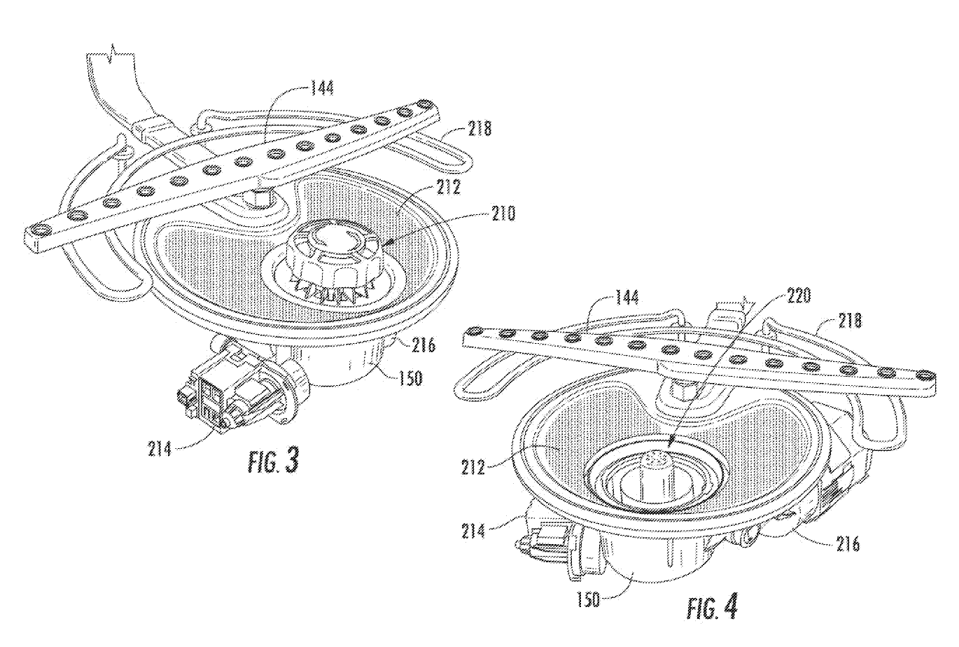

FIGS. 3 and 4 show perspective views of a bottom portion of a wash chamber 106. As shown, sump 150 is disposed beneath a fine particle filter housing 210 and substantially surrounded by a large filter 212. Liquid in the bottom of a wash chamber can drain into sump 150 either through fine particle filter housing 210 or through the various holes in large filter 212. As shown, a drain pump assembly 214 and a recirculation pump assembly 216 are attached to a side of sump 150 for pumping water out when desired. Heating element 218 is, e.g., provided for drying articles in rack assemblies 130, 132 (FIG. 1), and spray assembly 144 extends upward rotatably to spray wash fluid throughout wash chamber 106. The elements described so far are somewhat conventional, and various options and modifications are possible to the structure illustrated.

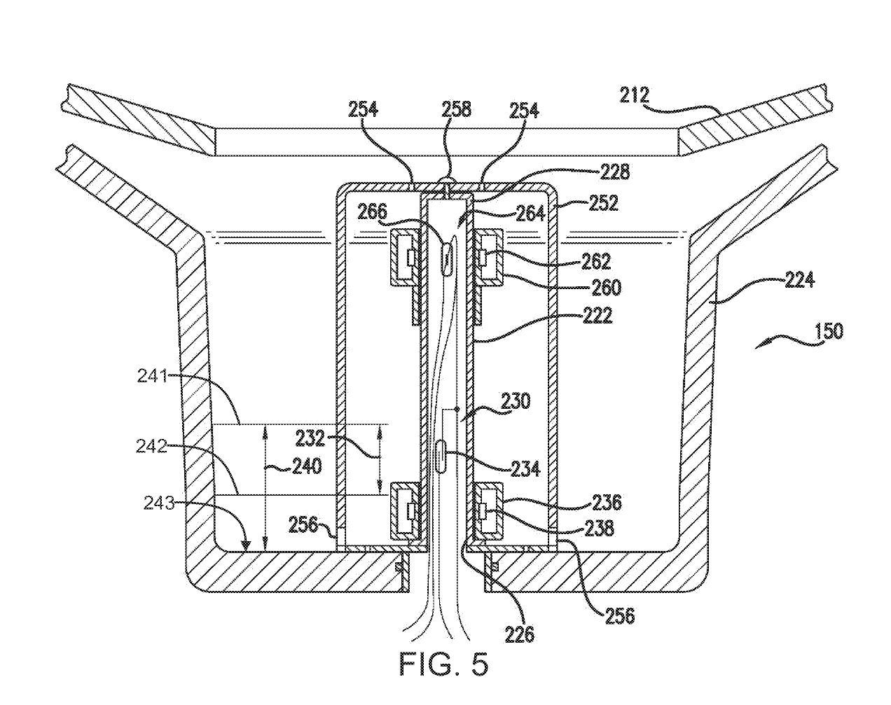

As shown in FIG. 4, fine particle filter housing 210 is removable from within large filter 212 by a user, for example for cleaning Removing fine particle filter housing 210 exposes the inside of sump 150 and a float valve 220 mounted in sump 150. FIG. 5 schematically shows the arrangement of float valve 220 within sump 150 in greater detail.

FIG. 5 shows a detailed diagrammatical depiction of sump 150 with one exemplary embodiment of a float valve 220. As shown, float valve 220 includes an upright hollow tube 222 mounted in sump housing 224. Openings (not shown in FIG. 5) may be provided in the sides or bottom of the sump housing 224 to attach passageways to fill or empty the sump, valves, pumps, etc., as discussed above. Tube 222 extends longitudinally between a base 226 and a tip 228. Tube 222 encloses at least one magnetically activated sensor device 230 having a vertical activation length 232 shorter than, but located within the full length of, the tube (from base 226 to tip 228).

As shown, sensor device 230 includes at least one reed switch 234 that can be changed between states by exposure to a magnetic field. As shown, reed switch 234 is a normally open reed switch that is closed (completing a circuit) when exposed to a sufficiently strong magnetic field. However, it should be understood that a normally closed reed switch could also be employed with corresponding changes in electrical connections as discussed below. It should be understood that other types of sensors may be employed. For example, a Hall Effect sensor could alternatively be employed.

As shown, at least one float 236 is movably mounted to tube 222 for floating on liquid within sump 150. Float 236 includes one or more magnets 238 therein for activating sensor device 230 when float 236 moves magnet 238 through activation length 232. Interacting ribs or other structure (not shown) may be provided on an inside surface of float 236 and the outside of tube 222 to maintain orientation of float 236 relative to tube 222, and accordingly to maintain magnet 238 at a given orientation relative to reed switch 234, if desired.

Vertical activation length 232 is the vertical distance over which magnet 238 changes the state of sensor device 230. Vertical activation length 232 extends between a first sump height 241 and a second sump height 242. Thus, magnet 238 changes the state of reed switch 234 when float 236 is positioned within vertical activation length 232, i.e., between first sump height 241 and a second sump height 242. Accordingly, when a volume of liquid fills sump 150 to some level between first sump height 241 and a second sump height 242, reed switch 234 is in the closed configuration. Alternatively, reed switch 234 is in the open configuration when a volume of liquid fills sump to some level above first sump height 241 or below second sump height 242. Reed switch 234 is electrically connected to controller 137 (FIG. 2).

Sump housing 224 has a known or determined volume, Vₖ, shown as 240 in FIG. 5. In particular, volume Vₖ of sump housing 224 corresponding to a volume of liquid that fills sump housing 224 from a bottom 243 of sump housing 224 to top of vertical activation length 232, i.e., from bottom 243 to first sump height 241. Volume Vₖ is discussed in greater detail below.

A protective cover 252 may be removably provided over tube 222. Openings 254 and 256 in cover 252 allow air and water to pass into and out of cover 252. Openings 254 and 256 or others should be large enough to allow the water level within cover 252 to be substantially the same as outside of cover so that the device is accurate as to flow in sump 150. Further, surrounding tube 222 with housing 252 prevents sloshing and potential inaccurate or discontinuous readings. Cover 252 may be attached to tube by a screw 258 or other user-operable structure.

A second float 260 with an embedded magnet or magnets 262 may be provided at a top area of tube 222. A sensor device 264 such as a reed switch 266 may be provided at this location as a “flood valve.” In other words, if sump becomes too full, either because too much water has been added, the drain is clogged, etc, as a safety mechanism the float 260 moves upward to deactivate reed switch 266, signaling controller 137 of the over-filled issue. Controller 137 may then signal the user via the user interface, turn off an inlet pump, turn on a drain pump, etc. as desired. Float 260 and sensor device 264 therefore need not be used to calculate a flow rate.

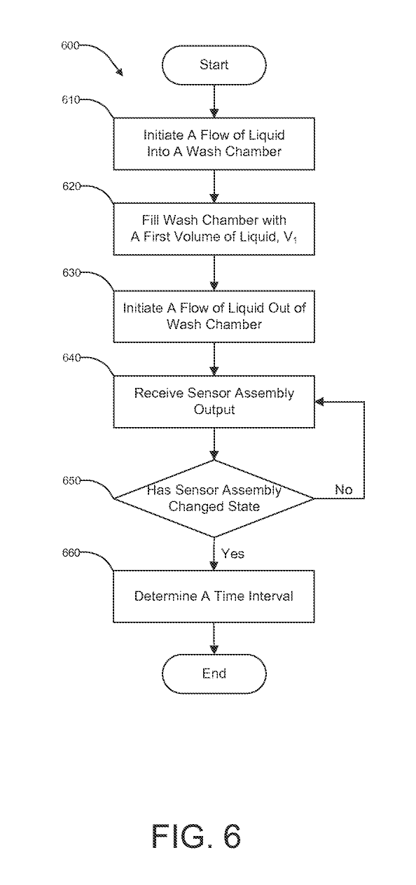

FIG. 6 illustrates an exemplary embodiment of a method 600 for operating a dishwasher appliance, e.g., dishwasher appliance 100 of FIG. 1. In method 600, a drain time interval, Δt_{d}, is determined. Interval Δt_{d} corresponds to an amount of time needed for a particular volume of liquid to drain from appliance 100. Interval Δt_{d} can be used to estimate the amount of liquid exiting appliance 100. In turn, interval Δt_{d} can be used to estimate the amount of liquid contained within wash chamber 106 of appliance 100.

Knowledge of the amount of liquid in appliance 100 can permit appliance 100 to operate more efficiently by utilizing an optimum amount of liquid for any particular cycle of the appliance 100. For example, if appliance 100 has a small, relatively clean load of articles in wash chamber 106, washing fluid used to clean such articles may be relatively clean at an end of the wash cycle. Because the washing fluid is relatively clean, the washing fluid can also be used to rinse the articles by adding a small amount of clean water to the washing fluid. Method 600 can be used to estimate the amount of washing fluid exiting appliance 100 prior to adding the clean water for rinsing. Controller 137 may be programmed to complete or perform the steps of method 600.

At step 610, a flow of liquid into wash chamber 106 (e.g., sump 150) of appliance 100 is initiated. For example, controller 137 may initiate the flow of liquid into wash chamber 106 by adjusting inlet assembly 199 such that water supply 200 permits water to flow into wash chamber 106. However, initiating the flow of liquid into wash chamber 106 may also be accomplished via any suitable alternative method. Step 610 may be initiated when liquid is needed within wash chamber 106, e.g., during a fill cycle of appliance 100 or during a partial fill cycle.

At 620, wash chamber 106 is filled with a first volume of liquid, V₁. Volume V₁ corresponds to a volume of liquid that fills sump 150 above first sump height 241 (FIG. 5). However, as will be understood by those skilled in the art, volume V₁ can vary according to the cycle of dishwasher appliance 100. For example, volume V₁ for any particular cycle may depend on the current cycle (e.g., wash or rinse) of the appliance 100, the relative dirtiness of articles being washed by appliance 100, and/or the amount of articles being washed by appliance 100.

At 630, a flow of liquid out of wash chamber 106 (e.g., sump 150) is commenced. For example, controller 137 may commence the flow of liquid out of wash chamber 106 by adjusting drain assembly 177 such that liquid is urged through drain 173 out of appliance 100 by drain pump 174. However, initiating the flow of liquid out of wash chamber 106 may also be accomplished via any suitable alternative method. Step 630 may be initiated, e.g., during a drain cycle or during a partial drain of appliance 100 to refresh wash fluid within sump 150.

Steps 640 and 650 are steps for monitoring an output of sensor device 230 until sensor device 230 changes state during draining of sump 150. As discussed above, volume V₁ corresponds to a volume of liquid that fills sump 150 above first sump height 241 (FIG. 5). Thus, at step 640, controller 137 initially receives a signal from sensor device 230 that reed switch 234 is in the open configuration due to volume V₁ of liquid filling sump 150 when draining of sump 150 begins at step 630.

Controller 137 continues to receive the signal that reed switch 234 is in the open configuration until a sufficient volume of liquid has drained from sump 150. In particular, when float 236 reaches first sump height 241, reed switch 234 will adjust from the open configuration to the closed configuration due to magnets 238 in float 236. Thus, when enough liquid has drain from sump 150, controller 137 will receive a signal from sensor device 230 that reed switch 234 is in the closed configuration, i.e.—that sensor device 230 has changed state.

As discussed above, volume Vₖ of liquid can fill sump 150 from bottom 243 to first sump height 241. Accordingly, when sensor assembly 230 changes state at step 650, it may be inferred that a second volume, V₂, of liquid fills sump 150 to first sump height 241, i.e.—the known volume Vₖ. Volume V₂ may be a calculated or measured. For example, volume V₂ can be calculated or measured during manufacture of dishwasher appliance 100.

At 660, interval Δt_{d} is determined. Interval Δt_{d} corresponds to an amount of time needed for drain pump assembly 174 to drain sump 150 from volume V₁ to volume V₂. As an example, a timer function of controller 137 can measure interval Δt_{d} from about when the flow of liquid out of wash chamber 106 is initiated at step 630 to about when sensor assembly 230 changes state at step 650. As another example, a first time, t₁, may be recorded by controller 137 that corresponds to about a time when the flow of liquid out of wash chamber 106 is initiated at step 630. A second time, t₂, may also be logged by controller 137 that corresponds to about a time when sensor assembly 230 changes state at step 650. In such example, interval Δt_{d} may be calculated as

Δt_{d}=t₂−t₁.

Controller 137 may store interval Δt_{d} for future use. Interval Δt_{d} can be used to calculate a fluid drain rate, F_{drain}, as discussed in greater detail below.

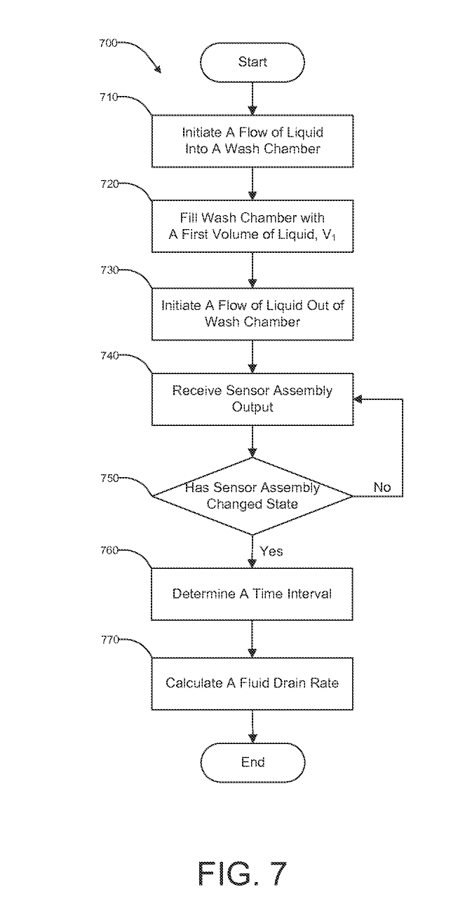

FIG. 7 illustrates an exemplary embodiment of a method 700 for operating a dishwasher appliance, e.g., dishwasher appliance 100 of FIG. 1. In method 700, rate F_{drain} is determined. Rate F_{drain} corresponds to a rate at which liquid drains from appliance 100. Like interval Δt_{d}, rate F_{drain} can be used to estimate the amount of liquid exiting appliance 100. In turn, rate F_{drain} can be used to estimate the amount of liquid contained within wash chamber 106 of appliance 100.

Method 700 is substantially similar to method 600 described above. Thus, for example, steps 710-760 may be performed in the same manner as steps 610-660. However, method 700 is directed to calculating a rate rather than a time interval.

To calculate rate F_{drain}, an accurate volume V₁ may be required. In method 700 (and method 600), volume V₁ may be measured by controller 137. For example, at step 710, controller 137 may initiate a flow of liquid into wash chamber 106 at about an initial time, tᵢ, by adjusting inlet assembly 199 such that water supply 200 permits water to flow into wash chamber 106. Subsequently, controller 137 may readjust inlet assembly 199 in order to terminate the flow of liquid into wash chamber 106 at about a subsequent time, tₛ. Between time tᵢ and time tₛ, liquid enters wash chamber 106 through inlet assembly 199. In other words, controller 137 permits the flow of liquid into the wash chamber 106 for a fill time interval, Δt_{f}, where

Δt_{f}=tₛ−tᵢ.

The flow of liquid into wash chamber 106 during interval Δt_{f} may be measured with flow meter 208 in order to generate a flow rate, F_{v/t}, of the flow of liquid into wash chamber 106. The flow of liquid into wash chamber 106 is generally continuous and constant. Thus, rate F_{v/t} measured by flow meter 208 is also generally constant. However, due to a variety of factors (e.g., changes in water supply pressure) rate F_{v/t} can change over time. In such conditions, controller 137 may, e.g., average rate F_{v/t} in order to compensate for such changes in rate F_{v/t} over time. Other suitable methods may be used to accurately measure rate F_{v/t}.

With rate F_{v/t} measured with flow meter 208, volume V₁ may be calculated as

V₁=F_{v/t}*Δt_{f}.

Controller 137 may calculate volume V₁ using the above formula in order to determine a volume of liquid contained in the wash chamber 106. Alternative methods may also be used, e.g., when liquid is contained within wash chamber 106 prior to step 710. For example, a prefill volume of liquid may be contained within wash chamber 106 prior to step 710. One skilled in the art will understand how to incorporate the prefill volume of liquid into calculations for volume V₁ (e.g., adding the prefill volume to the right-hand side of the formula for volume V₁ shown above).

Like in method 600, when sensor assembly 230 changes state at step 750, it may be inferred that volume V₂ of liquid fills sump 150. Accordingly, at step 770 rate F_{drain} may be calculated because volume V₁, volume V₂, and interval Δt_{d} are known. Rate F_{drain} may be calculated as

$${F}_{drain} = \frac{{V}_{1} - {V}_{2}}{Δ {t}_{d}} .$$

Other formulas and methods may be used to calculate rate F_{drain}. Controller 137 may store rate F_{drain} for future use.

Rate F_{drain} (volume/time) can be used to estimate the amount of liquid within appliance 100. For example, controller 137 may direct drain pump 174 to pump a given volume of water out of wash compartment 106 based upon rate F_{drain}. Therefore, rate F_{drain} can be used to fine tune the pumping. For another example, rather than just turning drain pump 174 on for a given, overly-conservative duration of time, controller 137 may activate drain pump 174 for a particular amount of time in order to remove a particular amount of liquid from sump 150. Such fine tuning can provide a more efficient use of water (with less waste and/or over-draining) Also, such fine tuning can prevent the sometimes noisy situation where drain pump 174 in sump 150 might over-drain sump 150, causing a loud air sucking sound.

In addition, rate F_{drain} can be benchmarked when washing machine 100 is built or installed. By measuring rate F_{drain}, using the method 600 described above, the measured rate F_{drain} can be compared to a preexisting table of benchmarked flow rates corresponding to different states stored within a memory of controller 137. Such states could be, e.g., normal drain, partial clog, heavy clog, etc. Such comparison by controller could be used to provide an indication of the state to a user via user interface device 136, to automatically stop, terminate or change cycles, reverse a pump automatically or manually to clear a clog, etc.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A dishwasher appliance comprising:
a tub defining a wash chamber for receipt of articles for washing;
an inlet assembly for selectively permitting a flow of liquid into the wash chamber of said tub;
a drain assembly for selectively drawing a flow of liquid out of the wash chamber of said tub;
a flow meter configured for measuring a flow rate, R_{v/t}, of the flow of liquid into the wash chamber of said tub;
a switch assembly configured for operating in a first state when liquid fills the wash chamber above a certain level and for operating in a second state when liquid fills the wash chamber below the certain level; and
a processing device in communication with said flow meter and said switch assembly, said processing device being configured for receiving rate R_{v/t} from said flow meter and for receiving a signal from said switch assembly when said switch assembly adjusts from the first state to the second state, said processing device also configured for determining a drain time interval based at least in part on rate R_{v/t} and said signal from said switch assembly, the drain time interval corresponding to an amount of time needed for a particular volume of liquid to exit the wash chamber of said tub through said drain assembly.

2. The appliance of claim 1, wherein said processing device is in communication with said inlet assembly and said drain assembly, said processing device configured for:
adjusting said inlet assembly in order to initiate a flow of liquid into the wash chamber of said tub;
measuring the flow of liquid into the wash chamber with said flow meter in order to determine rate R_{v/t} of the flow liquid into the wash chamber;
calculating a first volume of liquid, V₁, that fills the wash chamber of said tub based at least in part on rate R_{v/t};
activating said drain assembly in order to commence a flow of liquid out of the wash chamber;
logging a first time, t₁, that corresponds to about said step of activating;
detecting said switch assembly changing state when a second volume of liquid, V₂, fills the wash chamber to about the certain level;
recording a second time, t₂, that corresponds to about said step of detecting; and
determining the drain time interval based at least in part upon time t₁ and time t₂.

3. The appliance of claim 2, wherein said processing device is further configured for computing a fluid drain rate of said drain assembly based at least in part on time t₁ and time t₂.

4. The appliance of claim 3, wherein said step of computing comprises computing the fluid drain rate based at least in part on volume V₁, volume V₂, time t₁, and time t₂

5. The appliance of claim 2, wherein said processing device is further configured for:
documenting a third time, t₃, that corresponds to about said step of adjusting;
readjusting said inlet assembly in order to terminate the flow of liquid into the wash chamber of said tub; and
noting a fourth time, t₄, that corresponds to about said step of readjusting.

6. The appliance of claim 5, wherein said step of calculating comprises calculating volume V₁ based at least in part on rate R_{v/t}, time t₃, and time t₄.

7. The appliance of claim 1, wherein said tub includes a sump positioned adjacent a bottom of said tub and in fluid communication with said drain assembly, said switch assembly positioned within said sump and comprising:
an upright hollow tube housing at least one magnetically activated sensor device; and
at least one float movably mounted to said tube, the float including a magnet therein for activating the sensor device.

8. The appliance of claim 7, wherein the sensor device comprises a magnetic reed switch.

9. The appliance of claim 7, wherein the sensor device comprises a Hall Effect sensor.

10. The appliance of claim 1, wherein said processing device is further configured for saving the drain time interval.

11. A method for operating a dishwasher appliance, the method comprising:
initiating a flow of liquid into a wash chamber of the dishwasher appliance;
monitoring the flow of liquid with a flow meter in order to generate a flow rate, R_{v/t}, for the flow of liquid,
terminating the flow of liquid into the wash chamber of the dishwasher appliance;
calculating a first volume of liquid, V₁, that corresponds to a volume of liquid contained within the wash chamber at about said step of terminating based at least in part on rate R_{v/t};
commencing a flow of liquid out of the wash chamber of the dishwasher appliance;
detecting a switch assembly changing state when a second volume of liquid, V₂, fills the wash chamber; and
determining a drain time interval corresponding to an amount of time between about said step of commencing and about said step of detecting.

12. The method of claim 11, further comprising computing a drain rate of the liquid from the wash chamber based at least in part upon the drain time interval.

13. The method of claim 12, further comprising computing the drain rate of the liquid from the wash chamber based at least in part upon volume V₁ and volume V₂.

14. A dishwasher appliance comprising:
a tub that defines a wash chamber;
a drain assembly for selectively drawing a flow of liquid out of the wash chamber of said tub; and
means for calculating a fluid drain rate of said drain assembly.

15. The dishwasher appliance of claim 14, wherein said means for calculating comprises:
an inlet assembly for selectively permitting a flow of liquid into the wash chamber of said tub;
a flow meter configured for measuring a flow rate, R_{v/t}, of the flow of liquid into the wash chamber of said tub through said inlet assembly; and
a switch assembly configured for operating in a first state when liquid fills the wash chamber above a certain level and for operating in a second state when liquid fills the wash chamber below the certain level.

16. The appliance of claim 15, wherein said tub includes a sump in fluid communication with said drain assembly, said switch assembly positioned within said sump and comprising:
an upright hollow tube housing at least one magnetically activated sensor device; and
at least one float movably mounted to said tube, the float including a magnet therein for activating the sensor device.

17. The appliance of claim 16, wherein said switch assembly further comprises a magnetic reed switch.

18. The appliance of claim 16, wherein said switch assembly further comprises a Hall Effect sensor.
